(19) United States
(12) Patent Application Publication
(10) Pub. No.: US 2021/0152809 A1
(43) Pub. Date: May 20, 2021

(54) STRUCTURED LIGHT EMITTING DEVICE AND IMAGE ACQUISITON DEVICE UISNG SAME

(71) Applicant: TRIPLE WIN TECHNOLOGY(SHENZHEN) CO.LTD., Shenzhen (CN)

(72) Inventors: CHUN-YAO HUANG, New Taipei (TW); CHENG-AN LIN, New Taipei (TW)

(21) Appl. No.: 16/853,971

(22) Filed: Apr. 21, 2020

(30) Foreign Application Priority Data
Nov. 20, 2019 (CN) 201911139910.7

(51) Int. Cl. H04N 13/204; G02B 26/08; G02B 5/00; H04N 5/225; H04N 5/238

(52) U.S. Cl. CPC H04N 13/204; G02B 26/0833; H04N 5/238; H04N 5/2254; G02B 5/003

(57) ABSTRACT

A structured light emitting device includes a light emitting element configured to emit source light, a light modulator configured to modulate the source light into structured light and emit the structured light, and a lens. The lens is configured to transmit structured light. A lens controlling component is provided to drive the lens to synchronously move according to current motion information of the structured light emitting device. A controller is electrically coupled both the light emitting element and the light modulator. The controller is configured to control the light emitting element to emit the source light and control the light modulator to modulate the source light.

### FIELD

The subject matter herein generally relates to a technical field of 3-dimensional (3D) imaging, in particular to a structured light emitting device and an image acquisition device using the structured light emitting device.

### BACKGROUND

If depth information is to be acquired, structured light having a specific optical pattern (e.g., laser speckle) projected onto a measurable surface of an object can be used. A light source in the structured light device emits unpatterned light beams, so diffractive optical elements (DOE) is often used to scatter the light beams into a specific optical pattern. On one hand, the diffractive optical element is manufactured by forming a grating structure on a substrate by etching. A divergence angle of the incident beam and a shape of the projected light spot can be changed by changing the pattern of the grating structure, such that the light beam can have specific optical pattern. Therefore, different diffractive optical elements need to be customized according to their application scenarios and only correspond to a specific pattern, which lacks practicality and flexibility. Therefore, there is room for improvement in the art.

### BRIEF DESCRIPTION OF THE DRAWINGS

Implementations of the present technology will now be described, by way of embodiments only, with reference to the attached figures.

FIG. 1 is a schematic structural diagram of an image acquisition device and an object to be measured according to an embodiment of the present disclosure.

FIG. 2 is an isometric view of a structured light emitting device in the device of FIG. 1.

FIG. 3 is an exploded schematic view of the structured light emitting device of FIG. 2.

FIG. 4 is a cross-sectional view along line IV-IV of FIG. 2.

FIG. 5 is a schematic view showing a working state of a light modulator shown in FIG. 4.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

### First Embodiment

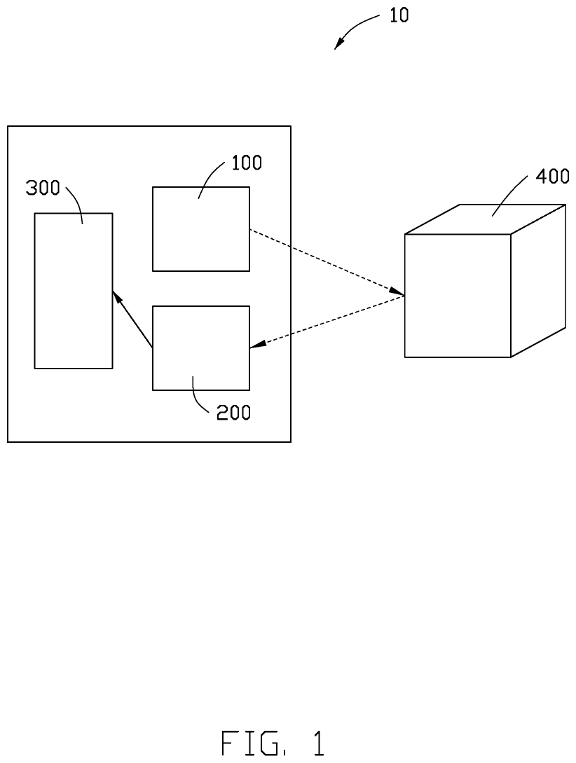

Referring to FIG. 1, an image acquisition device 10 provided in this embodiment is used to obtain a three-dimensional (3D) stereoscopic image of an object 400 to be measured. The image acquisition device 10 can be applied to the fields of 3D scanning and face recognition. The image acquisition device 10 may be a smart phone, a camera, a smart door lock or the like.

As shown in FIG. 1, the image acquisition device 10 includes a structured light emitting device 100, an optical sensor 200, and an image processor 300. The structured light emitting device 100 is configured to emit structured light. The structured light is irradiated on the object 400 to be measured and reflected by the object 400. The optical sensor 200 receives the structured light reflected by the object 400 and generates a structured-light image according to the reflected structured light.

The optical sensor 200 may be a charge coupled device (CCD) or a complementary metal-oxide semiconductor (CMOS). The image processor 300 is electrically connected to the optical sensor 200, and configured to receive the structured-light image and calculate position information and depth information of the object 400 to be measured according to the structured-light image, thereby obtaining a three-dimensional stereoscopic image of the object 400 to be measured. It should be understood that, the structured light reflected by the object 400 is deformed compared to the structured light emitted from the structured light emitting device 100 due to a surface morphology of the object 400, and the image processor 300 may calculate the position information and the depth information of the object 400 according to deformation of the structured light pattern, thereby realizing the three-dimensional stereoscopic image of the object 400.

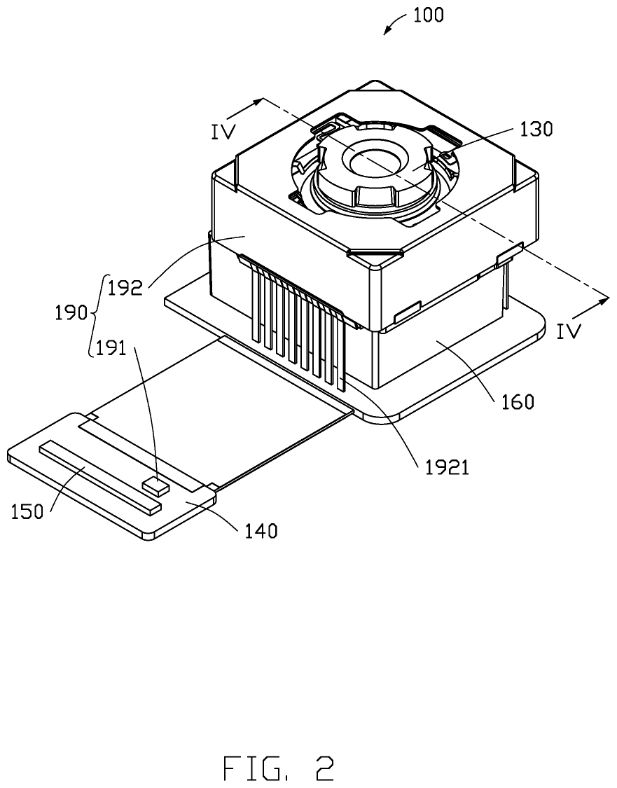

FIG. 2 through FIG. 4 shows the structured light emitting device 100. The structured light emitting device 100 includes a light emitting element 110, a light modulator 120, a lens 130, a circuit board 140, a controller 150, and a housing 160. The housing 161 is hollow and defines a receiving space 161. The circuit board 140 is located on a side of the housing 160 and covers the receiving space 161. The light emitting element 110 and the light modulator 120 are positioned on the circuit board 140 and in the receiving space 161. The controller 150 is positioned on the circuit board 140 and outside the receiving space 161. The housing 160 defines a light outlet 162 air communicating with the receiving space 161. The lens 130 is located on and covers the light outlet 162. The structured light of the structured light emitting device 100 passes through the lens 130 to the outside. The lens 130 and the circuit board 140 are located on opposite sides of the housing 160.

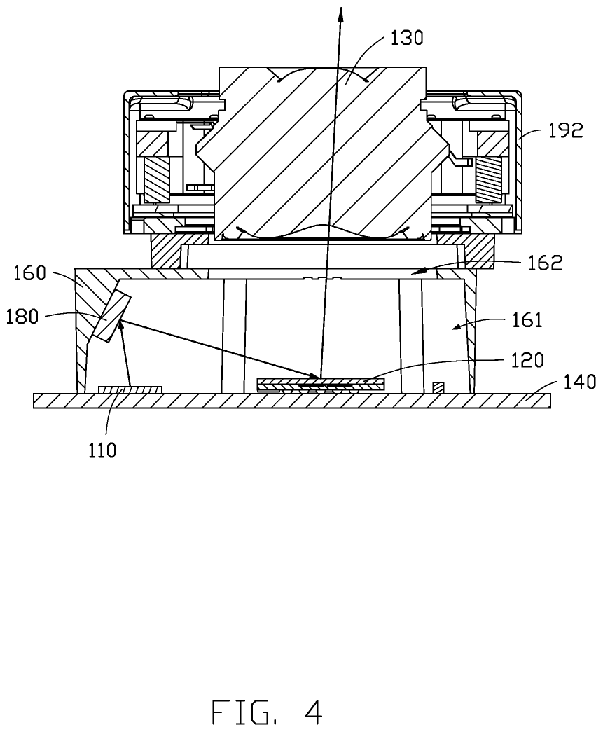

As shown in FIG. 4, the light emitting element 110 is source of light and used to emit source light. The light emitting element 110 may be an infrared laser emitting diode chip including a plurality of infrared laser diodes or an infrared light emitting diode chip including a plurality of infrared diodes. In this embodiment, the infrared laser diode is a vertical-cavity surface-emitting laser. The vertical-cavity surface-emitting laser requires less driving voltage and current, and has a lower power consumption, a high frequency that can reach several GHz; and is compatible with semiconductor manufacturing processes and is suitable for large-scale integrated manufacturing. In addition, a variation of emission wavelength of the vertical-cavity surface-emitting laser with temperature is only about 0.07 nm/O, so using the vertical-cavity surface-emitting laser is beneficial to reduce the influence of temperature on the emission wavelength of the laser to improve accuracy of structured-light projection. The controller 150 is electrically connected to the light emitting element 110 and is configured to control the light emitting element 110 to emit or not emit light.

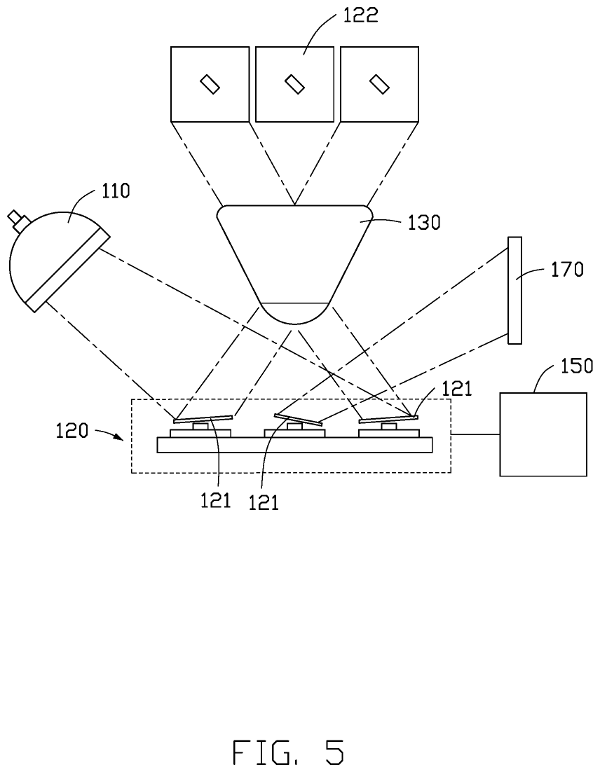

The light modulator 120 is configured to modulate the source light from the light emitting element 110 into the structured light. As shown in FIG. 4, in this embodiment, the light modulator 120 is a digital micromirror device (DMD). Specifically, as shown in FIG. 5, the light modulator 120 includes a plurality of micro-mirrors 121 spaced apart from each other. The micro-mirrors 121 are arranged in an array. Each micro-mirror 121 corresponds to a pixel 122 of a pattern of the structured light, and is configured for selectively projecting the source light into the lens 130. The greater a number of micro-mirrors 121, the higher a resolution of the pattern of structured light emitted from the structured light emitting device 100. The less the number of micro-mirrors 121, the lower is the resolution of the structured-light pattern emitted from the structured light emitting device 100. Each micro-mirror 121 has two states of “on” and “off”. When the micro-mirror 121 is in the “on” state, the micro-mirror 121 reflects received source light to the lens 130 and then the light passes through the lens 130 to the outside of the structured light emitting device 100. At this time, the pixel corresponding to the micro-mirror 121 in the pattern of structured light is “bright”. In this embodiment, as shown in FIG. 5, the structured light-emitting device 100 further includes a light-absorbing element 170 configured for absorbing light. When the micro-mirror 121 is in the “off” state, the micro-mirror 121 reflects the received source light to the light-absorbing element 170 and the light is absorbed by the light-absorbing element 170 without exiting from the lens 130, the pixel corresponding to the micro-mirror 121 in the pattern of structured light is “dark”.

The controller 150 is electrically connected to the light modulator 120, and configured to control deflection of each micro-mirror 121 to control the state of each micro-mirror 121, so as to control a brightness and darkness distribution of each pixel in the pattern of the structured light, thereby emitting different structured light patterns, which effectively improves the problem of a single pattern of structured light by using a single diffraction grating structure.

As shown in FIG. 4, the light emitting element 110 and the light modulator 120 are positioned on a same plane. In this embodiment, the light emitting element 110 and the light modulator 120 are a same surface of the circuit board 140. The light emitting element 110 emits the source light in a direction perpendicular to the plane, so light source light emitted by the light emitting element 110 cannot be directly emitted onto the light modulator 120. Therefore, in this embodiment, the structured light emitting device 100 further includes a light guiding element 180 on an optical path of the source light emitted by the light emitting element 110. The light guiding element 180 is configured to guide the source light to the light modulator 120.

In this embodiment, the light guiding element 180 is a reflective prism that is fixed on the housing 160 and is used to reflect the received source light to the light modulator 120. The installation angle of the reflecting prism on the housing 160 is determined according to a positional relationship between the light emitting element 110 and the light modulator 120. In other embodiments, the light guiding element 180 may be a lens, a right-angle prism, a trapezoidal prism, or other structure, and the structured light emitting device 100 may also include a plurality of light guiding elements 180.

In this embodiment, the housing 160 may be made of a metal or an alloy, such as copper, aluminum, iron, or stainless steel, to facilitate heat dissipation, which is beneficial to avoid a thermal saturation when temperature of the light emitting element 110 is high. The thermal saturation phenomenon is that a luminous intensity of the light-emitting element 110 no longer increases significantly or can even decrease as the current increases. In addition, since the housing 160 needs to be electrically insulated from the light emitting element 110, the housing 160 may be subjected to anodizing surface treatment (e.g., black anodizing treatment). The housing 160 can be made of plastic.

Referring to FIG. 1 again, the structured light emitting device 100 in this embodiment is particularly suitable for detecting a three-dimensional stereoscopic image of a solid and static object 400. The structured light emitted by the structured light emitting device 100 needs to be emitted to a predetermined position of the object 400. However, in some cases, the structured light emitting device 100 may be displaced during a detection process, for example, if the structured light emitting device 100 is applied by hand and the structured light emitting device 100 shakes with the user's arm. A displacement of the structured light emitting device 100 will shift the irradiation from a predetermined position, and detection result is affected.

As shown in FIG. 4, the structured light emitting device 100 in this embodiment further includes a lens controlling component 190. The lens controlling component 190 is configured to drive the lens 130 to synchronously move according to current motion information of the structured light emitting device 100, so that the structured light is emitted to the predetermined position of the object to be measured.

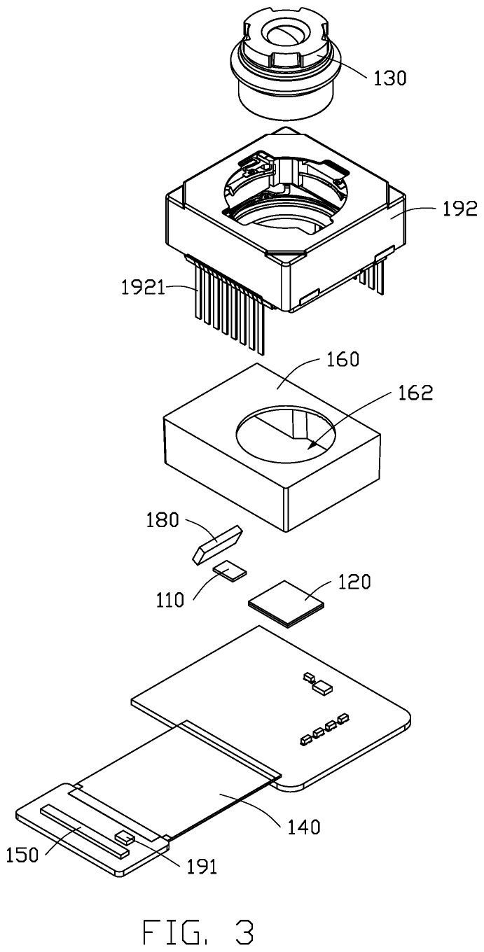

As shown in both FIG. 2 and FIG. 3, the lens controlling component 190 includes a motion detection unit 191 and a driving unit 192. In the present embodiment, the motion detection unit 191 is a gyroscope on the circuit board 140, which can detect the motion of the whole (center of gravity) of the structured light emitting device 100 and obtain motion information. The motion detection unit 191 is electrically coupled to the controller 150, and the controller 150 is configured to output a controlling signal according to the direction and distance of displacement. In this embodiment, the driving unit 192 is a voice coil motor, which is positioned in the optical path of the structured light and is located above the light outlet 162 of the housing 160. The driving unit 192 surrounds the lens 130.

As shown in FIG. 3, the driving unit 192 has a plurality of connecting pins 1921, and each connecting pin 1921 is connected to the circuit board 140. The driving unit 192 and the controller 150 are thus electrically connected, so that the controller 150 outputs controlling signals to the driving unit 192. In the present embodiment, the control signal is a signal based on current, and the driving unit 192 drives the lens 130 to generate a synchronous movement according to the current signal. The driving unit 192 controls a movement distance of the lens 130 according to an intensity of the current signal, and controls a movement direction of the lens 130 according to a magnetic field direction in the voice coil motor.

It should be understood that the above “synchronous movement” does not mean that the movements of the lens 130 and the structured light emitting device 100 are synchronized or consistent in the same direction and distance, but means that the movements of the lens 130 and the structured light emitting device 100 are synchronized in distance and just opposite in direction. For example, if the motion detection unit 191 detects that the structured light emitting device 100 has moved 30 mm to the left side, the controller 150 calculates a current value according to the movement distance and movement direction, and outputs a current signal to the driving unit 192 and the driving unit 192 drives the lens 130 to move 30 mm to the right side, so as to compensate for a shift of the structured light emitting position caused by the displacement of the structured light emitting device 100.

The structured light emitting device 100 in this embodiment effectively resolves a problem that the movement (or jitter) of the structured light emitting device 100 affects the detection result by providing the lens controlling component 190, which is beneficial for the structured light emitting device 100 emit toward a predetermined target location of the object to be measured in the case of displacement (or jitter).

In one embodiment, the structured light emitting device 100 may further include a lens (not shown), the lens may be positioned on an optical path of the structured light exiting from the light modulator 120, and the structured light exited from the light modulator 120 is collimated by the lens and then exits through the lens 130, which is beneficial to improve the light utilization. In other embodiments, the structured light emitting device 100 may also include a plurality of above lenses.

Even though information and advantages of the present embodiments have been set forth in the foregoing description, together with details of the structures and functions of the present embodiments, the disclosure is illustrative only. Changes may be made in detail, especially in matters of shape, size, and arrangement of parts within the principles of the present embodiments to the full extent indicated by the plain meaning of the terms in which the appended claims are expressed.

What is claimed is:

1. A structured light emitting device configured to emit structured light, comprising:
a light emitting element configured to emit source light;
a light modulator positioned on an optical path of the source light, the light modulator configured to modulate the source light into structured light and emit the structured light;
a lens transmitting the structured light;
a lens controlling component, the lens controlling component configured to drive the lens to synchronously move according to a current motion information of the structured light emitting device and the structured light is emitted to a predetermined position of an object; and
a controller electrically coupled to each of the light emitting element and the light modulator, the controller being configured to control the light emitting element to emit the source light and control the light modulator to modulate the source light.

2. The structured light emitting device of claim 1, wherein the lens controlling component comprises:
a motion detection unit electrically coupled to the controller and configured to detect and obtain the current motion information of the structured light emitting device; and
a driving unit electrically coupled to the controller, the controller configured to output a controlling signal to the driving unit according to the current motion information of the structured light emitting device, the driving unit configured to drive the lens to generate a synchronous movement with movement of the structured light emitting device.

3. The structured light emitting device of claim 2, wherein the current motion information of the structured light emitting device comprises a moving direction and a moving distance of the structured light emitting device.

4. The structured light emitting device of claim 2, wherein the motion detection unit is a gyroscope.

5. The structured light emitting device of claim 2, wherein the driving unit is a voice coil motor.

6. The structured light emitting device of claim 5, wherein the driving unit surrounds the lens.

7. The structured light emitting device of claim 1, wherein the light modulator light modulator is a digital micromirror device and comprises a plurality of micro-mirrors spaced apart from each other and arranged in an array; each of the plurality of micro-mirrors is configured for selectively projecting light into the lens.

8. The structured light emitting device of claim 7, further comprising a light-absorbing element, wherein the light-absorbing element is configured to absorb light reflected by at least one of the plurality of micro-mirrors.

9. The structured light emitting device of claim 1, wherein the light emitting element is an infrared laser emitting diode chip or an infrared light emitting diode chip.

10. An image acquisition device, comprising:
a structured light emitting device configured to emit structured light to an object, the structured light emitting device comprising:
a light emitting element configured to emit source light;
a light modulator positioned on an optical path of the source light, the light modulator configured to modulate the source light into structured light and emit the structured light;
a lens transmitting the structured light; and
a lens controlling component, the lens controlling component configured to drive the lens to synchronously move according to a current motion information of the structured light emitting device and the structured light is emitted to a predetermined position of an object; and
a controller electrically coupled both the light emitting element and the light modulator, the controller configured to control the light emitting element to emit the source light and control the light modulator to modulate the source light;
an optical sensor configured to receive the structured light reflected by the object and generate a structured-light image; and
an image processor electrically connected to the optical sensor and configured to receive the structured-light image and calculate position information and depth information of the object.

11. The image acquisition device of claim 10, wherein the lens controlling component comprises:
a motion detection unit electrically coupled to the controller and configured to detect and obtain the current motion information of the structured light emitting device; and
a driving unit electrically coupled to the controller, the controller configured to output a controlling signal to the driving unit according to the current motion information of the structured light emitting device, the driving unit configured to drive the lens to generate a synchronous movement with movement of the structured light emitting device.

12. The image acquisition device of claim 11, wherein the current motion information of the structured light emitting device comprises a moving direction and a moving distance of the structured light emitting device.

13. The image acquisition device of claim 11, wherein the motion detection unit is a gyroscope.

14. The image acquisition device of claim 11, wherein the driving unit is a voice coil motor.

15. The image acquisition device of claim 14, wherein the driving unit surrounds the lens.

16. The image acquisition device of claim 10, wherein the light modulator light modulator is a digital micromirror device and comprises a plurality of micro-mirrors spaced apart from each other and arranged in an array; each of the plurality of micro-mirrors is configured for selectively projecting light into the lens.

17. The image acquisition device of claim 16, further comprising a light-absorbing element, wherein the light-absorbing element is configured to absorb light reflected by at least one of the plurality of micro-mirrors.

18. The image acquisition device of claim 10, wherein the light emitting element is an infrared laser emitting diode chip or an infrared light emitting diode chip.
